(19) United States
(12) Patent Application Publication
(10) Pub. No.: US 2026/0319868 A1
(43) Pub. Date: Oct. 15, 2026

(54) Programmatic Container Scaling and Lifecycle Management via Object Workers

(71) Applicant: CLOUDFLARE, INC., SAN FRANCISCO, CA (US)

(72) Inventors: Brendan Martin Irvine-Broque, Oakland, CA (US); Thomas Alfred Georges Lefebvre, Pleasant Hill, CA (US); Kenton Taylor Varda, Austin, TX (US); Gabriel Jesus Villalonga Simon, Austin, TX (US); Michael Andrew Nomitch, Kirkland, WA (US); Nafeez Nazer, San Francisco, CA (US)

(21) Appl. No.: 19/437,742

(22) Filed: Dec. 31, 2025

Related U.S. Application Data
(60) Provisional application No. 63/786,942, filed on Apr. 10, 2025.

(51) Int. Cl. G06F 9/54; G06F 9/445

(52) U.S. Cl. CPC G06F 9/547; G06F 9/44505

(57) ABSTRACT

Techniques are described for providing programmatic container scaling and lifecycle management via persistent object workers in a container service. The container service enables users to launch and manage containers on cloud provider-managed infrastructure via a compute service, which users can use to execute custom third-party code. The ability for users to program the operation of code at the compute service, which serves as an ingress point to their containers, enables a broad set of custom container scaling and lifecycle management opportunities such as, for example, the ability to design custom container schedulers, autoscalers, load balancers, container routing, authorization layers, and the like.

### FIELD

Embodiments of the invention relate to the field of cloud compute services; and more specifically, to a cloud-based container service that uses persistent object workers for programmatic container scaling and lifecycle management.

### BACKGROUND

Many cloud-based services are available for deploying and running containers, each offering varying degrees of control over the underlying infrastructure. Some services provide users with near-complete control over compute resources, enabling manual configuration of virtual machines, networking, and other orchestration components. At the other end of the spectrum are fully managed, “serverless” container platforms that abstract away infrastructure management almost entirely, automatically handling deployment, scaling, and runtime environments on behalf of the user. While these serverless platforms ease many aspects of running containers in a cloud environment, the ability for users to directly configure orchestration behavior, routing, rate limiting, and the like, is often highly limited, typically requiring such configurations to occur through a separate control plane or management interface. As a result, users often face constraints when attempting to support complex container deployment scenarios unless those users adopt a more fully user managed and operationally intensive container deployment model.

### BRIEF DESCRIPTION OF THE DRAWINGS

The invention may best be understood by referring to the following description and accompanying drawings that are used to illustrate embodiments of the invention. In the drawings:

FIG. 1 illustrates a system for a container service of a distributed cloud computing network that enables users to programmatically customize container gateway and orchestration behavior according to some embodiments.

FIG. 2 illustrates the programmatic control of a container via an object worker deployed at a distributed cloud computing network according to some embodiments.

FIG. 3 illustrates the programmatic configuration of various gateway behaviors relative to a fleet of deployed containers in a distributed cloud computing network according to some embodiments.

FIG. 4 illustrates an example of secure communication between containers within a distributed cloud computing network according to some embodiments.

FIG. 5 is a flow diagram that illustrates exemplary operations for providing a container service enabling customized gateway and container orchestration behavior according to some embodiments.

FIG. 6 is a block diagram illustrating a data processing system that can be used in an embodiment.

### DESCRIPTION OF EMBODIMENTS

A cloud-based container service that enables users to programmatically manage container scaling and lifecycle behavior via persistent object workers is described. The container service enables users to launch and manage containers on cloud provider-managed infrastructure via a compute service, which users can use to execute custom third-party code. The ability for users to program the operation of code at the compute service, which serves as an ingress point to their containers, enables a broad set of custom container gateway and orchestration opportunities such as, for example, the ability to design custom container schedulers, load balancers, container routing, authorization layers, and the like. Conventional container services typically either abstract these configurations from the user through a separate control plane or management interface over which the user has limited, out-of-band control, or the configurations are left entirely up to the user to build themselves without the support of a robust compute layer and otherwise serverless container platform. The container service architecture described herein enables users to create highly performant gateway and orchestration configurations without the overhead of users needing to fully manage an entire container deployment environment, among other benefits.

Historically, web application code has been split between origin servers and browsers that are connected by a network that transmits data from point to point. Many large websites were first run on large physical mainframe servers that could handle large traffic and large data. Over time, a switch was made to run websites on tens to hundreds of commodity servers that allowed for a reduction in cost, more fault tolerance, and increased performance. The next switch was using virtual machines, where one physical machine could be split into multiple, independently managed virtual machines. Containers can be used to further provide isolation and can be even less resource intensive than virtual machines.

One of the key features of an operating system is the ability to run many processes at once. The operating system transparently switches between the various processes that want to run code at any given time. The operating system accomplishes this through a context switch that moves the memory required for one process out and the memory required for the next process in. A context switch can take as much as 100 microseconds. When multiplied by all the processes running on the average cloud computing platform server, this creates a heavy overhead. This means that not all the CPU's power can be devoted to actually executing the customer code, but rather some is spent switching between the processes.

Building and maintaining applications that easily scale to support spikes in demand or a global user base has generally required a large amount of both upfront engineering work and ongoing operational support. Developers are forced to spend significant time on writing supporting code rather than building the application itself. Many cloud computing platforms require the developer to specify where the code should run (e.g., at which nodes of the cloud computing platform), often with a small number of nodes that can be selected.

A distributed cloud computing network includes multiple compute servers that are geographically distributed (e.g., in different locations throughout the world). There may be hundreds of compute servers that are geographically distributed in different points-of-presences (PoPs). Each POP can include one or more physical servers (e.g., one or more compute servers, one or more control servers, one or more DNS servers (e.g., one or more authoritative name servers, one or more proxy DNS servers), and one or more other pieces of network equipment such as router(s), switch(es), and/or hub(s)). Each POP may be part of a different data center and/or colocation site. The distributed cloud computing network may provide different services for customers (e.g., domain owners or operators) such as protecting against internet-based threats, performance services (e.g., acting as a content delivery network (CDN) and dynamically caching customer's files closer to visitors, page acceleration/optimization), TCP stack optimizations, and/or other services.

Third-party code (e.g., written by or deployed by third-parties, such as customers) can be deployed to all or some of the compute servers of the distributed cloud computing network. The third-party code can be, for example, a piece of JavaScript or other dynamically-typed language, a WebAssembly (WASM) compiled piece of code, or other compiled code. In some examples, the third-party code is compliant with the W3C standard ServiceWorker API. The third-party code can, for example, intercept and answer HTTP requests and make outgoing HTTP subrequests as part of answering an HTTP request. In other examples, developers can modify request or response payloads on the fly, enabling use cases such as A/B testing, localization, and content injection. Beyond request handling, developers can deploy code implementing full-featured applications, such as dynamic web apps, APIs, artificial intelligence (AI) related apps, and the like. Because the distributed cloud computing network supports general-purpose code execution, users using third-party code can implement nearly any kind of logic or workflow that can be expressed in code, all without managing traditional server infrastructure. For purposes of this description, each piece of third-party code can be referred to as a worker script and an executed instance of the worker script is referred to as a worker.

In some examples, worker scripts are run in an execution environment that can safely run third-party code. Code in one execution environment cannot interfere with code running in a different execution environment. The execution environments are typically managed in user-space rather than by an operating system. Each execution environment uses its own method to ensure secure resource access, such as restricting code to its allocated resources and isolating it within a controlled memory domain, such as a system-level namespace, a runtime-managed address space, or an isolated heap. For purposes of description, this type of execution environment is sometimes referred herein as an isolated execution environment. Such an isolated execution environment can take various forms, including lightweight isolates like those provided by the V8 JavaScript engine, as well as more comprehensive containerization technologies, virtual machines, microVMs (e.g., Firecracker microVMs), hardware-assisted virtualization environments, paravirtualization environments, dedicated “bare metal” servers, Java Virtual Machine (JVM) environments, Python interpreter environments, and similar mechanisms that provide strong isolation boundaries.

In some examples, a particular worker script is loaded and executed on-demand (when and only if it is needed) at a particular compute server of the distributed cloud computing network. Each request for a Uniform Resource Locator (URL) that triggers handling of a worker script (e.g., because the URL matches a route bound to a worker script), in some examples, is handled by the worker script at a compute server that is closest (e.g., in terms of network hops, geographic proximity, or other measures) to the requesting user. For instance, when responding to a user in New Zealand, a worker script might run in a compute server in New Zealand that is closest to the user. In some examples, the compute server that receives the request may be determined by the network infrastructure according to an Anycast implementation, by a geo-aware load balancer, latency-based routing, using client-side hints, or any combination thereof.

In some examples, one particular type of worker script is referred to herein as an object worker script. An object worker includes a combination of an instantiation of the object worker script and an object that belongs to that instantiation of the object worker script. An object worker is associated with a particular identifier or key and is further configured to maintain persistent state information across multiple invocations (e.g., by storing the data in a key-value store, database, or other type of data store). Unlike other workers, which generally are stateless and execute independently of prior invocations, an object worker can retain data between executions and provide a consistent execution context for operations relating to the associated identifier. In some examples, a single instance of an object worker is instantiated per identifier, and execution requests directed to that identifier are routed to the corresponding instance. This ensures, for example, that stateful operations are processed in a serialized and isolated manner, enabling the object worker to perform coordinated updates, maintain data integrity, and support logic that depends on historical context. In some examples, object workers are executed at the network edge or within distributed environments and can be used to manage session state, counters, coordination primitives, or other application-specific data.

As described in more detail elsewhere herein, in some examples, a container service uses object workers as a “sidecar” application for the containers developers desire to be launched in the distributed cloud computing network. A user can launch a container by creating a container-aware object worker (e.g., by extending and instantiating an object worker class in their worker script code) that includes built-in functionality for interacting with a companion container. The built-in functionality can include operations for starting and stopping a container, invoking execution of commands or applications within the container, accessing state or health information associated with the container, and the like. In this manner, users can create and scale the number of containers launched on their behalf by programmatically creating any number of desired container-aware object workers at runtime.

As indicated, in some examples, users can create worker scripts configured to launch containers in a distributed cloud computing network. The ability for workers scripts to launch containers enables many different container-based use cases including: executing user or LLM-generated code in any language in a secure container sandbox; executing a command-line interface (CLI) tool that needs a full Linux environment; executing an application requiring memory or CPU requirements that exceed that of other compute service offerings; porting existing applications from other cloud provider environments; and executing container code from an agent, among many other possible use cases. For these use cases and many others, users can enable the use cases by writing custom third-party worker script code and deploying the worker scripts to the distributed cloud computing network, as described in more detail elsewhere herein. Furthermore, due in part to the integration with the distributed cloud computing network's compute services, users can create worker scripts providing API gateway services (e.g., allowing for control over routing behavior, authentication, caching, rate limiting, etc.), service mesh functionality (e.g., enabling private connections between containers with a programmable routing layer), custom orchestration behavior (e.g., enabling custom scheduling, scaling, and health checking logic), among other possibilities.

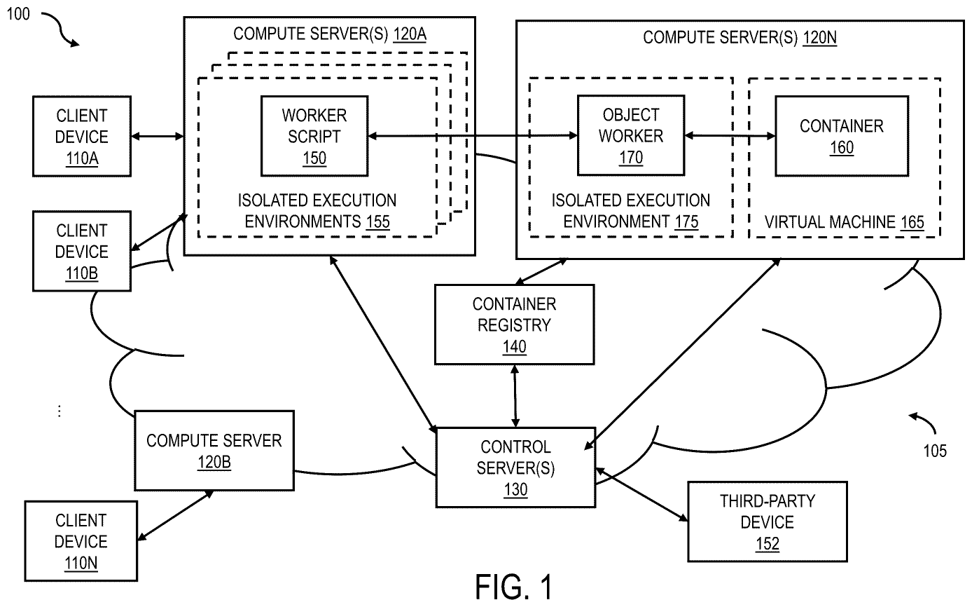

FIG. 1 illustrates a system for a cloud-based container service providing programmable gateway and orchestration behavior according to some examples. The cloud computing platform may provide different services such as protecting against internet-based threats, providing performance services for customers (e.g., acting as a content delivery network (CDN) and dynamically caching customers' files close to visitors, page acceleration, etc.), TCP stack optimizations, among other potential services. The system 100 includes the client devices 110A-N, the compute servers 120A-N, the control server(s) 130, the container registry 140, and the third-party device 152.

Each client device is a computing device (e.g., laptop, workstation, smartphone, mobile phone, tablet, gaming system, set top box, wearable device, Internet of Things (IoT) device, etc.) that is capable of transmitting and/or receiving network traffic. Each client device may execute a client network application such as a web browser, native application, or other application that can access network resources (e.g., web pages, images, word processing documents, PDF files, movie files, music files, or other computer files).

The compute servers 120A-N are part of the cloud computing platform. The compute servers 120A-N are physical servers and are geographically distributed (e.g., in different locations throughout the world). The compute servers 120A-N are part of the distributed cloud computing network 105. There may be hundreds or thousands of compute servers as part of the cloud computing platform. Although not illustrated in FIG. 1, the compute servers 120A-N may be part of PoPs that can include other physical servers (e.g., one or more compute servers, one or more control servers, one or more DNS servers (e.g., one or more authoritative name servers, one or more proxy DNS servers), and one or more other pieces of network equipment such as router(s), switch(es), and/or hub(s)). Each PoP (and each compute server) may be part of a different data center and/or colocation site. Although not illustrated in FIG. 1, there are other physical devices between the compute servers 120A-N such as routers, switches, etc.

The control server(s) 130 is operated by the cloud computing platform and provides a set of tools and interfaces for a customer to, among other things, configure code (e.g., worker scripts such as worker script 150 running in an isolated execution environment 155) and containers (e.g., a container 160 running on a virtual machine 165 or other execution environment) to run in the cloud computing platform. In some examples, the control server 130 allows the customer to upload one or more worker scripts and further allows the customer to specify when the worker script(s) are to be run. For instance, the customer can associate a rule that indicates when a worker script is to be run. By way of example, the control server 130 may allow the customer to configure a URL matching pattern that indicates the URL(s) for which the worker script is to run. The control server 130 may allow the customer to delete and update previously uploaded worker script(s).

The control server 130 deploys each worker script to each of the compute servers 120A-N automatically (without the customer selecting which of the compute servers 120A-N in which to deploy the worker script). In another embodiment, the control server 130 allows the customer to indicate to which of the compute servers 120A-N a particular worker script is to be deployed. The control server 130 creates an identifier for each unique worker script. In an example, the identifier is created by hashing the content of the worker script (e.g., using a cryptographic hash function such as SHA-256), where two scripts with identical content will have the same identifier even if uploaded by different customers and even if applied to different zones.

In an embodiment, the control server 130 allows a customer to provision the service to the cloud computing platform through DNS. For example, DNS record(s) of a customer are changed such that DNS records of hostnames point to an IP address of a compute server instead of the origin server. In some embodiments, the authoritative name server of the customer's domain is changed to an authoritative name server of the service and/or individual DNS records are changed to point to the compute server (or point to other domain(s) that point to a compute server of the service). For example, the customers may change their DNS records to point to a CNAME record that points to a compute server of the service. In one embodiment, customers may use the control server 130 to change their authoritative name server to an authoritative name server of the cloud computing platform and/or change their zone file records to have their domain point to the compute servers.

The third-party device 152 is a computing device (e.g., laptop, workstation, smartphone, mobile phone, tablet, etc.) that is used by third-parties to, among other things, configure their third-party code and containers to run in the cloud computing platform. A third-party may be a customer of the cloud computing platform and/or a party that is configuring third-party code and containers to run in the cloud computing platform.

In some examples, requests from client devices are directed to an origin server, which may be owned or operated directly or indirectly by the customer of the cloud computing platform, and which is a computing device on which a network resource resides and/or originates (e.g., web pages, images, word processing documents, PDF files movie files, music files, or other computer files). In an embodiment, the origin server is not required to be in the cloud computing platform (e.g., third-party code may run on the compute servers without communicating with an origin server).

The compute servers 120A-N are geographically distributed which decreases the distance between requesting client devices and the compute servers and decreases the time necessary to respond to a request. The compute servers 120A-N may operate as a reverse proxy and receive requests for network resources (e.g., HTTP requests) of a domain of an origin server. The particular compute server 120 that receives a request from a client device may be determined by the network infrastructure according to an Anycast implementation, by a geo-aware load balancer, or other method. For instance, the compute servers 120A-N may have the same anycast IP address for a domain of an origin server or other resource. If the origin server handles the domain “example.com”, a DNS request for “example.com” returns an address record having the anycast IP address of the compute servers 120A-N. Which one of the compute servers 120A-N receives a request from a client device depends on which compute server 120 is closest to the client device in terms of routing protocol configuration (e.g., Border Gateway Protocol (BGP) configuration) according to an anycast implementation as determined by the network infrastructure (e.g., router(s), switch(es), and/or other network equipment between the requesting client and the compute servers 120A-N. By way of example, the client device 110A is closest to the compute server 120A, the client device 110N is closest to the compute server 120B, and so forth. Accordingly, requests from the client device 110A are received at the compute server 120A, while requests from the client device 110N are received at the compute server 120B, etc. The number of client devices and compute servers illustrated in FIG. 1 is exemplary. The distributed cloud computing network 105 may include hundreds to thousands (or more) compute servers and each compute server may receive requests from thousands or more client devices.

In the example of FIG. 1, each of the compute servers 120A-N can execute the worker script(s) of a third-party. Each worker script is run in an isolated execution environment, such as run in an isolate of the V8 JavaScript engine or other type of execution environment. Thus, as illustrated in FIG. 1, the compute server 120A includes the isolated execution environments 155 that each executes a separate worker script 150. In some examples, the isolated execution environments 155 are run within a single process. In other examples, the worker scripts are executed using a virtual machine, container, or other execution environment. In an embodiment, a particular worker script is loaded and executed on-demand (when and only if it is needed) at a particular compute server of the distributed cloud computing network. Each request for a domain that triggers handling of a worker script will be handled by the worker at the compute server that is closest to the requesting user.

As shown in FIG. 1, each of the compute servers 120A-N can also execute object workers, such as object worker 170 running in an isolated execution environment 175. As described elsewhere herein, in some examples, an object worker 170 is a type of worker that is associated with a particular identifier or key and is further configured to maintain persistent state information across multiple invocations. An object worker 170 similarly executes in an isolated execution environment 175, which can be a single process, a virtual machine, a container, or any other type of execution environment. In the context of a container service provided by the distributed cloud computing network, one type of object worker 170 provides an interface by which worker scripts (e.g., worker script 150) can perform actions with respect to an associated container 160. The container 160 runs in a virtual machine (e.g., a Firecracker microVM) or other container execution environment. An object worker 170 and associated container 160 may be deployed on a same compute server, or on different compute servers and communicate over a secure network. In some examples, an object worker 170 can route requests and other data to and from an associated container via one or more communication channels that enable RPC or other similar services.

To launch a container, a user can write third-party code (e.g., as part of a workers script) including instructions to launch an instance of the container in the distributed cloud computing network. In some examples, the third-party code can cause a container instance to be launched by defining an object worker that is pre-configured with operations for interacting with an associated container. In this manner, the third-party worker code can create and launch containers on-demand at run time.

The cloud-based container service providing programmable gateway and orchestration behavior can be used to deploy an application with a stateful workload. The following code snippet is an example of third-party code (e.g., part of a worker script) that is used for a platform where end-users can run code generated by an LLM, where multiple requests are run in sequence, potentially writing to local files or saving in-memory state. In this code, a container is created on-demand for each user session, where subsequent requests are routed to that container.

```
import { Container } from “cloud:workers”;
export default {
  async fetch(request, env) {
    const url = new URL(request.url);
    if (url.pathname.startsWith(″/execute-code″)) {
      const { sessionId, messages } = await request.json( );
      // pass in prompt to get the code from Llama 4
      const codeToExecute = await env.AI.run(″@cloud/meta/llama-4-scout-17b-16e-instruct″, {
messages });
// get a different container for each user session
      const id = env.CODE_EXECUTOR.idFromName(sessionId);
      const sandbox = env.CODE_EXECUTOR.get(id);
// execute a request on the container
      return sandbox.fetch(″/execute-code″, { method: ″POST″, body: codeToExecute });
    }
    // ... rest of code...
  },
};
// define your container using the Container class from cloud:workers
export class CodeExecutor extends Container {
    defaultPort: 8080,
    sleepAfter: ″1m″
}
```

In this example, the Container class is imported from the cloud: workers module. The fetch method is an asynchronous function that takes in the request (an object representing the incoming HTTP request) and an environment object. The fetch function defines how the worker responds to requests. In this example, the code passes in a prompt to generate code from an LLM. Each time the third-party code requests a container (e.g., by executing a command such as “env.CODE_EXECUTOR.get (id)” in the third-party code, where CODE_EXECUTOR is a reference to an associated object worker), the third-party code sends requests to a unique container instance. The container will automatically boot on the first fetch, then put itself to sleep after a configurable timeout, in this case 1 minute. The third-party code can then cause the execution of second code, where the second code is part of the referenced object worker, that launches the container upon request (e.g., responsive to the third-party code calling “env.CODE_EXECUTOR.get (id)”, which returns a stub (a lightweight local object representing a connection to a possibly remote object worker)). Once the container is launched, the third-party code can call further actions with respect to the container by executing requests on the object worker stub (e.g., “return sandbox.fetch (“/execute-code”, {method: “POST”, body: codeToExecute});”). In this example, the code generated by the LLM is forwarded to the container to be executed within the container. Thus, the untrusted code generated by an LLM can be run by each user in their own secure environment.

The cloud-based container service providing programmable gateway and orchestration behavior can be used to deploy an application that is stateless and autoscaling. As an example of such an application, consider code that is running within a container that takes a video file and turns it into a GIF. Unlike the example of executing code generated by an LLM, in this case any container can serve any request. In order to limit the amount of data sent for the application, the application is deployed in multiple locations in the distributed cloud computing network. In this example, the configuration data associated with a user's third party code identifies the location of one or more containers and other associated configurations. As an illustrative example:

```
“containers”: [
  {
    “class_name”: “GifMaker”,
    “image”: “./Dockerfile”, // location of container source code
    “instance_type”: “basic”
    “autoscaling”: {
      “minimum_instances”: 1,
      “cpu_target”: 75,
    }
  }
],
```

In the example configuration above, a user has defined a container with an associated class name “GifMaker” and further provided a storage location of an associated container specification. In some examples, when a user deploys their application and associated configuration information via a control server 130, the control server 130 obtains the identified container specification, builds a container image based on the container specification, and stores the container image in a container registry 140. The control server 130 may further optionally pre-warm the container or container environment (e.g., by starting up and initializing a container runtime ahead of time) at one or more locations in the distributed cloud computing network.

The user has further specified optional autoscaling configurations (e.g., indicating that the user desires for there to be a minimum of 1 instance running in each region and, if CPU usage increases beyond 75% of capacity, for additional container instances to be automatically added by the container service) in the example configuration. Users can optionally configure these and other similar orchestration configurations to enable the container service to perform some orchestration behaviors on the users behalf, if so desired.

To route requests to the container, the user can configure code to call the env.GIF_MAKER.fetch function to automatically route requests to the closest container, as shown in the following code snippet:

```
import { Container } from “cloud:workers”;
export class GifMaker extends Container {
  defaultPort: 1337,
}
export default {
  async fetch(request, env) {
    const url = new URL(request.url);
    if (url.pathname === ″/make-gif″) {
      return env.GIF_MAKER.fetch(request)
    }
    // ... rest of code...
  },
};
```

For example, the return env.GIF_MAKER.fetch (request) forwards the original request to the nearest instance of the GifMaker container.

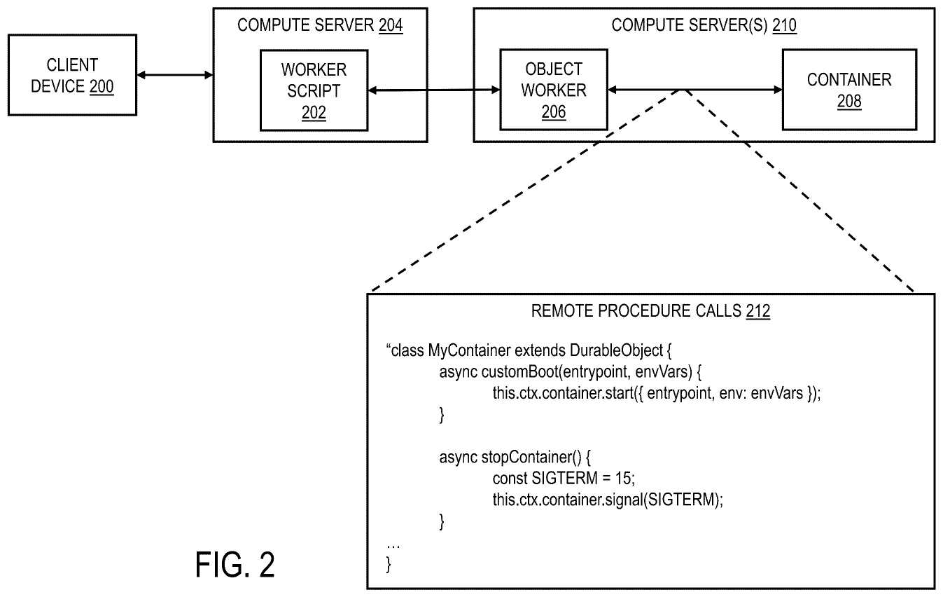

FIG. 2 illustrates the programmatic control of a container via an object worker deployed at a distributed cloud computing network according to some embodiments. The example in FIG. 2, for example, illustrates a user creating code in a worker script to manually start, stop, and execute commands on a specific container by calling remote procedure call (RPC) methods on a container's associated object worker. Prior to the operations illustrated in FIG. 2, a user has provided third party code and associated configuration data indicating a desire to launch one or more containers at the distributed cloud computing network. As indicated above, the user may desire to run the container at the distributed cloud computing network to securely run user-generated code within the container; to execute an application with relatively extensive memory, CPU, or GPU requirements (e.g., AI workloads); to port an application from a different container-based environment, among many other possibilities.

In the example of FIG. 2, a defined “MyContainer” class includes custom methods “customBoot” and “stopContainer” that can be called by a user's worker script 202, as described above, which causes remote procedure calls 212 to be called by the object worker 206 on its associated container 208. In this manner, users can launch containers by simply defining a container as described above, creating an object worker 206 in their worker script 202 code, and performing arbitrary actions relative to a container 208 by defining the actions in their worker script 202 code. The container service manages the underlying mechanics of launching the container 208 at a compute server 210 at a location that provides low latency performance relative to the location of the compute server 204 and, by extension, the client device 200. In some examples, the container service further causes the container to pause or sleep after a configurable timeout period.

As another example, a user can create code in their worker script used to monitor a container and run hooks in response to container status changes. For instance, assume a user has a continuous integration (CI) job that runs builds in a container. The user further desires to post messages to a queue based on the exit status of the container. In this example, the user might program this behavior in their worker script:

```
class BuilderContainer extends StatefulService {
  constructor(ctx, env) {
    super(ctx, env)
    async function onContainerExit( ) {
      await this.env.QUEUE.send({ status: “success”, message: “Build Complete” });
    }
    async function onContainerError(err) {
      await this.env.QUEUE.send({ status: “error”, message: err});
    }
    this.ctx.container.start( );
    this.ctx.container.monitor( ).then(onContainerExit).catch(onContainerError);
  }
  async isRunning( ) { return this.ctx.container.running }
}
```

In this example, the BuilderContainer class extends a StatefulService class used to create object worker instances. The object worker class includes a function called “onContainerExit( )” that, upon execution, sends a status message to a queue indicating that the container exited successfully, and includes another function called “onContainerError (err)” that, upon execution, sends a status message to the queue with an error message in the event the container did not exit successfully. The code then monitors the execution of the container and invokes the appropriate function depending on the container's exit status.

As yet another example, a user might desire for state to be loaded into a container each time the container runs. In this case, the user can create a worker script that includes status hooks to persist state from the container before it sleeps and to reload state into the container after it starts. As an illustrative example:

```
import { startAndWaitForPort } from “./helpers”
class MyContainer extends StatefulService {
  constructor(ctx, env) {
    super(ctx, env)
    this.ctx.blockConcurrencyWhile(async ( ) => {
      this.ctx.storage.sql.exec(‘CREATE TABLE IF NOT EXISTS state (value TEXT)’);
      this.ctx.storage.sql.exec(‘INSERT INTO state (value) SELECT ‘’ WHERE NOT EXISTS
(SELECT * FROM state)’);
      await startAndWaitForPort(this.ctx.container, 8080);
      await this.setupContainer( );
      this.ctx.container.monitor( ).then(this.onContainerExit);
    });
  }
  async setupContainer( ) {
    const initialState = this.ctx.storage.sql.exec(‘SELECT * FROM state LIMIT 1’).one( ).value;
    const req = new Request(
      ‘http://container/state’,
      { body: initialState, method: ‘POST’ }
    );
    return await this.ctx.container
      .getTcpPort(8080)
      .fetch(req);
  }
  async onContainerExit( ) {
    const response = await this.ctx.container
      .getTcpPort(8080)
      .fetch(‘http://container/state’);
    const newState = await response.text( );
    this.ctx.storage.sql.exec(‘UPDATE state SET value = ?’, newState);
  }
}
```

In the code snippet above, in the “onContainerExit ( )” function, the code requests the container's state (e.g., “const response=await this.ctx.container.getTcpPort (8080).fetch (‘http://container/state’);”) and stores the state information in a database table. The “setupContainer ( )” function similarly obtains the state information from the database table and sends the obtained state information to the container.

In some examples, the container service further enables users to create custom scheduling and scaling logic beyond what the user can configure in their initial container configuration. For example, a user's containers might have a protracted startup period that involves loading data from an external source. In this case, a user might desire to pre-warm the containers manually and to do so in a specific region (e.g., close to where the data the containers use is located). The following is an example of worker script code for performing such orchestration actions:

```
class MyContainer extends ObjectWorker {
  constructor(ctx, env) {
    super(ctx, env);
    this.ctx.container.start( );
    this.ctx.blockConcurrencyWhile(async ( ) => {
      await this.ctx.storage.setAlarm(Date.now( ));
    });
  }
  async alarm( ) {
    try {
      await this.healthcheck( );
    } finally {
      await this.ctx.storage.setAlarm(Date.now( ) + 500);
    }
  }
  async healthcheck( ) {
    const manager = this.env.MANAGER.get(this.env.MANAGER.idFromName(″manager″));
    const id = this.ctx.id.toString( );
    return this.ctx.container.getTcpPort(8000)
      .fetch(new Request(″http://container/_health″))
      .then(( ) => {
          return manager.setHealthy(id, true);
      }).catch(( ) => {
        return manager.setHealthy(id, false);
      });
  }
}
class ContainerManager extends ObjectWorker {
  scale(region, instanceCount) {
    for (let i = 0; i < instanceCount; i++) {
      const containerId = env.CONTAINER.idFromName(‘instance-${region}-${i}‘);
      // spawns a new DO container
      await env.CONTAINER.get(containerId, { locationHint: region }).init( );
    }
  }
  async setHealthy(containerId, isHealthy) {
    await this.ctx.storage.put(containerId, isHealthy);
  }
}
```

In this example, the ContainerManager object worker object exposes an RPC call named “scale,” which can be called on-demand with a region and an instanceCount used to scale the number of active container instances in a given region using a location hint. Further, the “alarm ( )” function executes a manually defined health check on the container and tracks its state in the object worker for use by other logic. As illustrated by this example, users can programmatically provide for arbitrarily complex container scheduling logic.

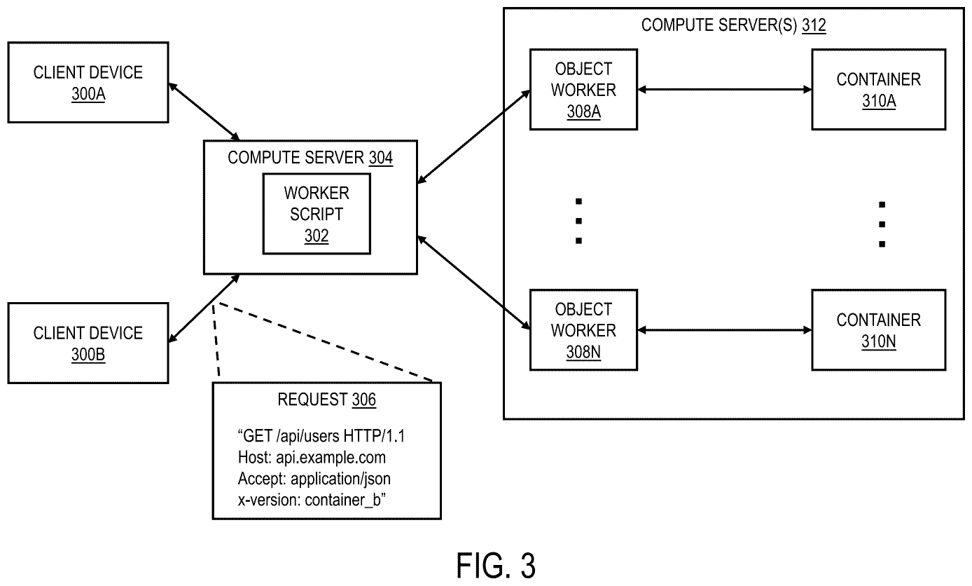

FIG. 3 illustrates the programmatic control of various gateway behaviors relative to a fleet of deployed containers in a distributed cloud computing network according to some embodiments. The examples shown above illustrate how users can configure fine-grained control over a container's lifecycle via a container's associated object worker. As illustrated hereinafter, the container service further allows users to extend routing, scheduling, and other container gateway behaviors, which can be used as an API gateway, for example.

In the example of FIG. 3, multiple client devices (e.g., a client device 300A and a client device 300B) each invoke execution of a worker script 302 running on a compute server 304. The worker script 302 includes code that launches and uses at least two different containers (e.g., including a container 310A and container 310N). These containers are respectively associated with an object worker 308A and 308N executing on the compute server(s) 312. In other examples, the worker script 302 may define and launch any number of different containers. For example, the different containers may represent different versions of an application used for A/B testing, application experimentation, or any other purpose.

The worker script 302 includes code that directs requests from the client devices to an appropriate one of the containers 310A-N depending on the characteristics of the requests sent from the client devices. For example, the worker script 302 might route ordinary requests from client device 300A to a container 310A and route requests with a specific header (e.g., “x-version: container_b”) to a different container 310N. In this example, the worker script 302 includes logic that defines the routing such as identifying when a request includes a specific header that informs the routing decision. For instance, the worker script 302 determines that the request 306 includes the header “x-version: container_b” and is to be routed to the container 310N. Accordingly, the worker script 302 routes the request 306 to the object worker 308N that is associated with the container 310N. In general, a worker script can define any arbitrary routing logic based on any characteristics of the incoming requests or other environment variables (e.g., time of day, rate of requests, etc.). In this manner, a user can use the compute service to customize and program gateway-like functionality in front of their containers such as routing, authentication, caching, and rate-limiting.

As another example, a user might desire to rate limit and authenticate requests to a container as follows:

```
async fetch(request, env) {
  const url = new URL(request.url);
  if (url.pathname.startsWith(‘/api/’)) {
    const token = request.headers.get(“token”);
    const isAuthenticated = await authenticateRequest(token);
    if (!isAuthenticated) {
      return new Response(“Not authenticated”, { status: 401 });
    }
    const { withinRateLimit } = await env.MY_RATE_LIMITER.limit({ key: token });
    if (!withinRateLimit) {
      return new Response(“Rate limit exceeded for token”, { status: 429 });
    }
    return env.MY_APP.fetch(request);
  }
  // ...
}
```

In the example above, the code determines whether a request for a container includes a valid token and further that a rate of requests associated with the token are within a rate limit defined in custom rate limiting logic.

As indicated, an object worker can act as a proxy to an associated container in the described container service. In some examples, an object worker can additionally act as a proxy from an associated container. For example, when the creator of a worker script configures a container, the creator can toggle Internet access off and ensure that outgoing requests pass through its associated object worker and the associated secure network of the distributed cloud computing network. For example, the code associated with a worker script might include:

```
// ... when starting the container...
this.ctx.container.start({
    workersAddress: ‘10.0.0.2:8080’,
    enableInternet: false
});
// ... container requests to ‘10.0.0.2:8080’ securely route to a different service...
override async onContainerRequest(request: Request) {
  const containerId = this.env.SUB_SERVICE.idFromName(request.headers[‘X-Account-Id’]);
  return this.env.SUB_SERVICE.get(containerId).fetch(request);
}
```

In the example above, container requests to the 10.0.0.2:8080 address are routed to a specific container via an associated object worker. The ability to route requests from containers in this manner enables users to securely connect containers within the distributed cloud provider network, or even when connecting to external private networks.

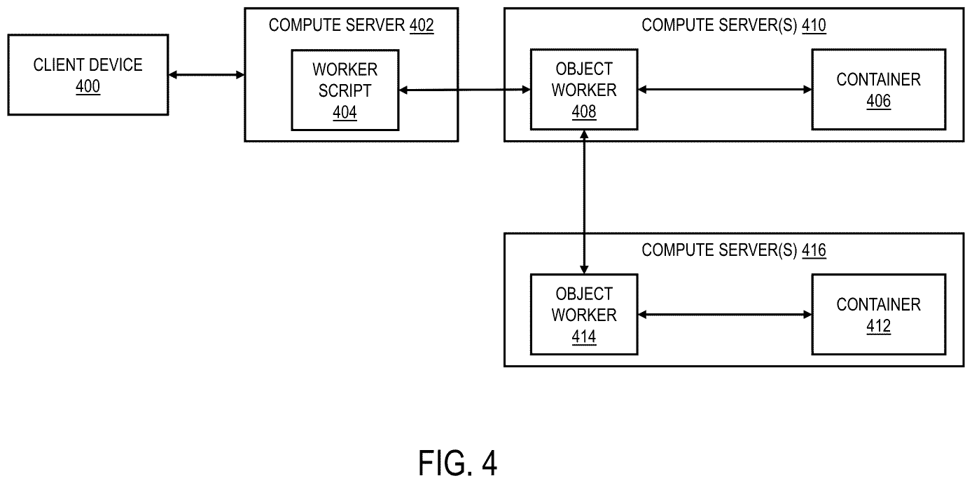

FIG. 4 illustrates an example of secure communication between containers (e.g., as a service mesh) within a distributed cloud computing network according to some embodiments. In FIG. 4, a client device 400 generates requests received by a compute server 402 of a distributed cloud computing network. Based on the requests, the compute server 402 executes a worker script 404, which includes instructions for launching and otherwise interacting with a container 406. As described elsewhere herein, this interaction is facilitated by an associated object worker 408 (where the object worker 408 and container 406 run on one more compute server(s) 410 of the distributed cloud computing network).

In the example of FIG. 4, the container 406 is configured such that connections to the public Internet are disabled. Requests to the container 406 are routed from the container 406 to a different container 412 via the object worker 408 and object worker 414, respectively, where the object worker 414 and container 412 run on the compute server(s) 416.

The cloud-based container service described herein can be used with multiple-step applications and/or artificial intelligence (AI) tools or agents. For example, consider a workload that requires downloading a large file from object storage, compressing the file, and uploading the file to object storage. The following code snippet, which can be a worker script, shows the worker downloading the file from object storage, the container compressing the file (the downloaded file is sent to the container to compress the object using the container.fetch function), and the worker uploading the compressed file to object storage.

```
export class EncoderWorkflow extends WorkflowEntrypoint<Env, Params> {
  async run(event: WorkflowEvent<Params>, step: WorkflowStep) {
    const id = this.env.ENCODER.idFromName(event.instanceId);
    const container = this.env.ENCODER.get(id);
      await step.do(′init container′, async ( ) => {
    await container.init( );
    });
    await step.do(′compress the object with zstd′, async ( ) => {
      await container.ensureHealthy( );
      const object = await this.env.ARTIFACTS.get(event.payload.r2Path);
      const result = await container.fetch(′http://encoder/zstd′, {
method: ′POST′, body: object.body
      });
      await this.env.ARTIFACTS.put(‘results${event.payload.r2Path}‘, result.body);
    });
    await step.do(′cleanup container′, async ( ) => {
      await container.destroy( );
    });
  }
}
```

For instance, consider an AI agent that needs to spin up cloud infrastructure. A tool (a structured way for an AI agent or workflow to invoke APIs, manipulate data, and/or integrate with external systems) is created to enable an AI agent to run shell commands from a container. The following code snippet defines a tool for an agent to run Terraform in a container using a tool function, and sends a request to a container to apply a Terraform configuration. The code initiates a request to the container managed by the object worker using the fetch function. This code allows an AI agent to dynamically provision infrastructure using Terraform in a secure, isolated container. Each sessionID gets its own object worker, ensuring separation between users or tasks.

```
// Make tools that call to a container from an agent
const createExternalResources = tool({
  description: “runs Terraform in a container to create resources”,
  parameters: z.object({ sessionId: z.number( ), config: z.string( ) }),
  execute: async ({ sessionId, config }) => {
    return this.env.TERRAFORM_RUNNER.get(sessionId).applyConfig(config);
  },
});
// Expose RPC Methods that call to the container
class TerraformRunner extends ObjectWorker {
  async applyConfig(config) {
    await this.ctx.container.getTcpPort(8080).fetch(APPLY_URL, {
      method: ‘POST’,
      body: JSON.stringify({ config }),
    });
  }
  // ...rest of code for object worker...
}
```

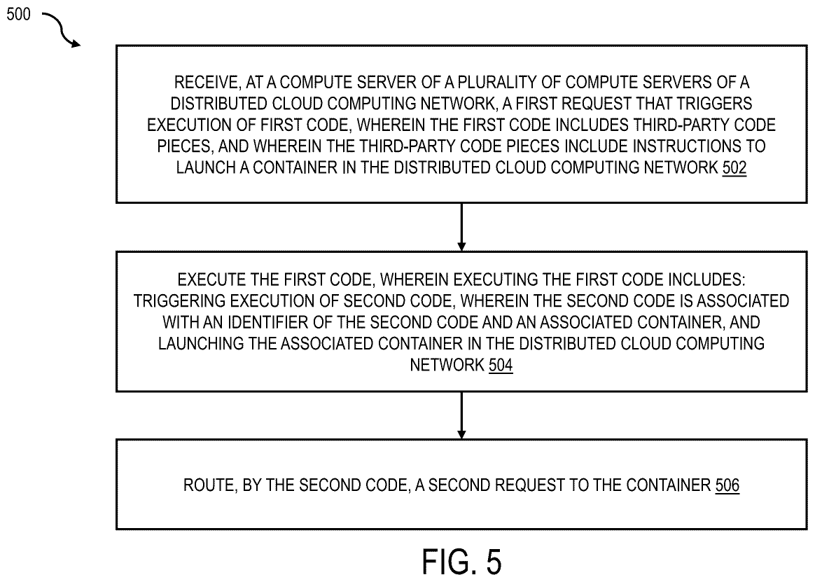

FIG. 5 is a flow diagram illustrating operations 500 of a method for providing a container service enabling customized gateway and container orchestration behavior according to some embodiments. Some or all of the operations 500 (or other processes described herein, or variations, and/or combinations thereof) are performed under the control of one or more computer systems configured with executable instructions and are implemented as code (for example, executable instructions, one or more computer programs, or one or more applications) executing collectively on one or more processors, by hardware or combinations thereof. The code is stored on a computer-readable storage medium, for example, in the form of a computer program comprising instructions executable by one or more processors. The computer-readable storage medium is non-transitory. In some embodiments, one or more (or all) of the operations 500 are performed by compute servers 120A-120N, control server(s) 130, or other components of a distributed cloud computing network 105 of the other figures.

At operation 502, a compute server of a plurality of compute servers of a distributed cloud computing network receives a first request that triggers execution of first code, wherein the first code includes third-party code pieces, and wherein the third-party code pieces include instructions to launch a container in the distributed cloud computing network. For example, in reference to FIG. 1, a compute server 120A might receive a request from a client device 110A, where the request invokes execution of a worker script 150 based on a URL or other characteristic of the request.

At operation 504, the first code is executed, including: triggering execution of second code, wherein execution of the second code is associated with an identifier of the second code and a container associated with the second code, and launching the container in the distributed cloud computing network. In reference to FIG. 1, execution of a worker script 150 can trigger execution of code implementing an object worker 170 (e.g., based on second code) that causes a container 160 to be launched in the distributed cloud computing network.

At operation 506, the second code routes a second request to the container. For example, the second code can route the second request to the container using a communication channel established between an instance of the second code and the container (possibly via a virtual machine or other execution environment hosting the container). The communication channels can include a capability-based RPC communication channel or any other channel enabling an associated instance of the second code (e.g., an object worker 170) to communicate with an associated container. The second request can include routing any information to the associated container (e.g., to invoke execution of a command or application that is part of the container).

In some examples, the compute server is a first compute server, and wherein the operations further include: receiving, by a second compute server of the plurality of compute servers of the distributed cloud computing network, a request to deploy a worker including the first code and worker configuration data, wherein the worker configuration data includes a container specification; building a container image based on the container specification; and storing the container image in a container registry of the distributed cloud computing network. As described elsewhere herein, a user can use a third-party device 152 to deploy a worker script and associated configuration data to a control server 130. In some examples, upon receiving a request to deploy a worker script and associated configuration data identifying a container, the control server 130 or other component of the distributed cloud computing network builds a container image based on a container specification identified in the configuration data, and stores the container image in a container registry 140. The container images stored in the container registry 140, for example, can be used by compute instances when launching containers.

In some examples, the container is a first container, execution of the second code is first execution of the second code, and executing the first code further includes: triggering a second execution of the second code, wherein the second execution of the second code causes the launch of a second container, wherein the first container and the second container are based on a same container image. For example, a user can create a worker script that launches multiple container instances based on a same container image to support additional load, for deployment in multiple regions of the distributed cloud computing network, or for other purposes.

In some examples, the container is a first container, and the operations further include: receiving a third request invoking execution of the first code; identifying, by the first code, a characteristic of the third request; and routing a fourth request to a second container based on the characteristic of the third request, wherein the second container is based on a container image that differs from a container image upon which the first container is based. As illustrated in FIG. 3, for example, a worker script can implement API gateway-like functionality that causes a worker to route requests to one of possibly multiple different containers based on headers or other characteristics of an incoming request.

In some examples, executing the first code includes executing a command to stop the container, and wherein the command to stop the container includes a call to code in the second code. As illustrated in FIG. 2, for example, the first code can include commands that cause second code (e.g., associated with an instance of an object worker) to implement RPC calls or other mechanisms for starting, stopping, obtaining a health status, or performing other operations on an associated container.

In some examples, the container is a first container, and executing the first code further includes: receiving a request directed to a second container launched in the distributed cloud computing network; and routing the request to the second container via an instance of the second code associated with the second container. As illustrated in FIG. 4, for example, the object workers associated with containers can provide a service mesh by which containers, or other external applications, can securely communicate with one another within the distributed cloud computing network.

In some examples, executing the first code further includes: determining a rate of requests to the container; and responsive to determining that the rate of requests to the container exceeds a defined rate limit, blocking a request. For example, a worker script 150 can implement custom rate limiting, authentication, or other logic as part of serving as an intelligent gateway for associated containers.

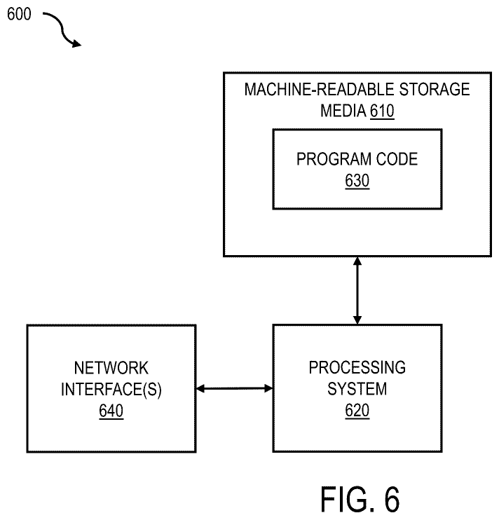

FIG. 6 illustrates a block diagram for an exemplary data processing system 600 that may be used in some embodiments. One or more such data processing systems 600 may be utilized to implement the embodiments and operations described with respect to a compute server or other servers described herein. Data processing system 600 includes a processing system 620 (e.g., one or more processors and connected system components such as multiple connected chips).

The data processing system 600 is an electronic device that stores and transmits (internally and/or with other electronic devices over a network) code (which is composed of software instructions and which is sometimes referred to as computer program code or a computer program) and/or data using machine-readable media (also called computer-readable media), such as machine-readable storage media 610 (e.g., magnetic disks, optical disks, read only memory (ROM), flash memory devices, phase change memory) and machine-readable transmission media (also called a carrier) (e.g., electrical, optical, radio, acoustical or other form of propagated signals-such as carrier waves, infrared signals), which is coupled to the processing system 620. For example, the depicted machine-readable storage media 610 may store program code 630 that, when executed by the processing system 620, causes the data processing system 600 to execute the isolated execution environments, the worker scripts, the object workers, and/or the containers, and/or any of the operations described herein.

The data processing system 600 also includes one or more network interfaces 640 (e.g., a wired and/or wireless interfaces) that allows the data processing system 600 to transmit data and receive data from other computing devices, typically across one or more networks (e.g., Local Area Networks (LANs), the Internet, etc.). The data processing system 600 may also include one or more input or output (“I/O”) components such as a mouse, keypad, keyboard, a touch panel or a multi-touch input panel, camera, frame grabber, optical scanner, an audio input/output subsystem (which may include a microphone and/or a speaker), other known I/O devices or a combination of such I/O devices. Additional components, not shown, may also be part of the system 600, and, in certain embodiments, fewer components than that shown in the figure can be used. One or more buses may be used to interconnect the various components shown in FIG. 6.

The techniques shown in the figures can be implemented using code and data stored and executed on one or more electronic devices (e.g., a compute server). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals-such as carrier waves, infrared signals, digital signals). In addition, such electronic devices typically include a set of one or more processors coupled to one or more other components, such as one or more storage devices (non-transitory computer-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

References in the specification to “one embodiment,” “an embodiment,” “an example embodiment,” etc., indicate that the embodiment described may include a particular feature, structure, or characteristic, but every embodiment may not necessarily include the feature, structure, or characteristic. Moreover, such phrases are not necessarily referring to the same embodiment. Further, when a particular feature, structure, or characteristic is described in connection with an embodiment, one skilled in the art would understand how to implement such feature, structure, or characteristic in connection with other embodiments whether explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the preceding description and the claims, the terms “coupled” and “connected,” along with their derivatives, may be used. These terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

While the flow diagrams in the figures show a particular order of operations performed by certain embodiments of the invention, such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method, comprising:
receiving, at a compute server of a distributed cloud computing network, a request to execute an object worker, wherein the object worker is a combination of an instantiation of third-party code and an object that belongs to that instantiation of the third-party code, wherein the object worker is configured to maintain persistent state information across multiple invocations, and wherein the object worker is associated with a unique identifier; and
executing the object worker, wherein executing the object worker includes:
receiving a command specifying a container instance count,
executing orchestration logic defined within the third-party code to iteratively launch a plurality of containers in the distributed cloud computing network until a number of launched containers corresponds to the container instance count, and
maintaining, in the persistent state information of the object worker, state information for the launched plurality of containers to enable subsequent lifecycle management of the launched plurality of containers by the object worker.

2. The method of claim 1, wherein the command further specifies a target region, and wherein launching the plurality of containers further comprises:
providing a location hint derived from the target region to a container service of the distributed cloud computing network, wherein the location hint causes the launched plurality of containers to be launched at compute servers associated with the target region.

3. The method of claim 1, wherein executing the orchestration logic further includes:
scheduling an alarm event within the object worker; and
responsive to the alarm event, executing a health check function that requests a status of at least one of the launched plurality of containers.

4. The method of claim 1, wherein executing the object worker further includes:
scheduling an alarm event within the object worker;
responsive to the alarm event, executing a health check function that requests a status of at least one of the launched plurality of containers; and
updating the state information stored within the object worker to reflect an indicated status of the health check function.

5. The method of claim 1, wherein the object worker executes in an isolated execution environment, and wherein the command is a Remote Procedure Call (RPC).

6. The method of claim 1, wherein executing the orchestration logic further includes: initiating a pre-warming sequence for the launched plurality of containers, wherein the pre-warming sequence initializes a container runtime for the distinct launched plurality of containers prior to routing requests to said launched plurality of containers.

7. The method of claim 1, wherein launching the plurality of containers includes configuring the plurality of containers to disable public Internet access, and wherein the object worker acts as a proxy for outbound requests generated by the plurality of containers.

8. The method of claim 1, wherein launching the plurality of containers includes applying a configuration parameter that causes a container of the plurality of containers to enter a sleep mode after a configurable timeout period.

9. A non-transitory computer-readable storage medium that, if executed by a processor of a compute server, will cause said compute server to perform operations, comprising:
receiving, at the compute server of a distributed cloud computing network, a request to execute an object worker, wherein the object worker is a combination of an instantiation of third-party code and an object that belongs to that instantiation of the third-party code, wherein the object worker is configured to maintain persistent state information across multiple invocations, and wherein the object worker is associated with a unique identifier; and
executing the object worker, wherein executing the object worker includes:
receiving a command specifying a container instance count,
executing orchestration logic defined within the third-party code to iteratively launch a plurality of containers in the distributed cloud computing network until a number of launched containers corresponds to the container instance count, and
maintaining, in the persistent state information of the object worker, state information for the launched plurality of containers to enable subsequent lifecycle management of the launched plurality of containers by the object worker.

10. The non-transitory computer-readable storage medium of claim 9, wherein the command further specifies a target region, and wherein launching the plurality of containers further comprises:
providing a location hint derived from the target region to a container service of the distributed cloud computing network, wherein the location hint causes the launched plurality of containers to be launched at compute servers associated with the target region.

11. The non-transitory computer-readable storage medium of claim 9, wherein executing the orchestration logic further includes:
scheduling an alarm event within the object worker; and
responsive to the alarm event, executing a health check function that requests a status of at least one of the launched plurality of containers.

12. The non-transitory computer-readable storage medium of claim 9, wherein executing the object worker further includes:
scheduling an alarm event within the object worker;
responsive to the alarm event, executing a health check function that requests a status of at least one of the launched plurality of containers; and
updating the state information stored within the object worker to reflect an indicated status of the health check function.

13. The non-transitory computer-readable storage medium of claim 9, wherein the object worker executes in an isolated execution environment, and wherein the command is a Remote Procedure Call (RPC).

14. The non-transitory computer-readable storage medium of claim 9, wherein executing the orchestration logic further includes: initiating a pre-warming sequence for the launched plurality of containers, wherein the pre-warming sequence initializes a container runtime for the distinct launched plurality of containers prior to routing requests to said launched plurality of containers.

15. The non-transitory computer-readable storage medium of claim 9, wherein launching the plurality of containers includes configuring the plurality of containers to disable public Internet access, and wherein the object worker acts as a proxy for outbound requests generated by the plurality of containers.

16. The non-transitory computer-readable storage medium of claim 9, wherein launching the plurality of containers includes applying a configuration parameter that causes a container of the plurality of containers to enter a sleep mode after a configurable timeout period.

17. A compute server, comprising:
a processing system; and
a non-transitory machine-readable storage medium coupled to the processing system,
wherein the non-transitory machine-readable storage medium stores instructions that, when executed by the processing system, causes the compute server to perform operations including:
receiving, at the compute server of a distributed cloud computing network, a request to execute an object worker, wherein the object worker is a combination of an instantiation of third-party code and an object that belongs to that instantiation of the third-party code, wherein the object worker is configured to maintain persistent state information across multiple invocations, and wherein the object worker is associated with a unique identifier; and
executing the object worker, wherein executing the object worker includes:
receiving a command specifying a container instance count,
executing orchestration logic defined within the third-party code to iteratively launch a plurality of containers in the distributed cloud computing network until a number of launched containers corresponds to the container instance count, and
maintaining, in the persistent state information of the object worker, state information for the launched plurality of containers to enable subsequent lifecycle management of the launched plurality of containers by the object worker.

18. The compute server of claim 17, wherein the command further specifies a target region, and wherein launching the plurality of containers further comprises:
providing a location hint derived from the target region to a container service of the distributed cloud computing network, wherein the location hint causes the launched plurality of launched containers to be launched at compute servers associated with the target region.

19. The compute server of claim 17, wherein executing the orchestration logic further includes:
scheduling an alarm event within the object worker; and
responsive to the alarm event, executing a health check function that requests a status of at least one of the launched plurality of containers.

20. The compute server of claim 17, wherein executing the object worker further includes:
scheduling an alarm event within the object worker;
responsive to the alarm event, executing a health check function that requests a status of at least one of the launched plurality of containers; and
updating the state information stored within the object worker to reflect an indicated status of the health check function.
